(19) United States
(12) Patent Application Publication
(10) Pub. No.: US 2006/0164854 A1
(43) Pub. Date: Jul. 27, 2006

(54) Onboard lamp fixture for a vehicle

(75) Inventor: Cheng-Chung Chen, Taipei Hsien (TW)

Correspondence Address: NIKOLAI & MERSEREAU, P.A., 900 SECOND AVENUE SOUTH, SUITE 820, MINNEAPOLIS, MN, 55402, US

(73) Assignee: JULUEN ENTERPRISE CO., LTD., Shu Lin City (TW)

(21) Appl. No.: 11/043,919

(22) Filed: Jan. 24, 2005

(51) Int. Cl. B60Q 1/00

(52) U.S. Cl. 362/549; 362/548

(57) ABSTRACT

An onboard lamp fixture for a vehicle includes a hollow conical body. The conical body is divided into a top portion having multiple flanges formed on an outer periphery of the top portion and multiple indentations each defined between two adjacent flanges, a middle portion having multiple intermittently formed threads on an outer periphery of the middle portion and annular gaps each defined between two adjacent threads and a bottom portion. After the conical body is extended through a through hole, a bottom face defining the annular gap of each thread is able to engage with an outer periphery defining the through hole and the flanges are able to securely engage with an inner periphery defining the through hole to secure the conical body.

### BACKGROUND OF THE INVENTION

1. Field of the Invention

The present invention relates to an onboard lamp fixture, and more particularly to an onboard lamp fixture for a vehicle and adapted to be securely extended into holes of different dimensions.

2. Description of Related Art

Lamps are widely used on vehicles to illuminate the surroundings. Because different sized cars have different dimensioned holes, lamp manufacturers have to prepare lamps of different dimensions to adapt to the holes. Besides, due to different requirements, lamp holes in trucks are normally larger in dimension than the lamp holes in cars. Thus the manufacturers have to prepare different dimensioned lamps to fit into the trucks and the cars, which is a waste in cost.

To overcome the shortcomings, the present invention tends to provide an improved lamp fixture to mitigate the aforementioned problems.

### SUMMARY OF THE INVENTION

The primary objective of the present invention is to provide a lamp fixture for a vehicle to adapt to different holes of different dimensions.

In order to accomplish the aforementioned objective, the lamp fixture of the present invention includes a hollow conical body divided into a top portion, a middle portion and a bottom portion. The conical body has a bottom opening and a top opening so that a lamp set is able to be received and extended out of the conical body. A transparent enclosure is optionally mounted on top of the conical body for enclosing the lamp extended out of the conical body. The top portion has multiple flanges extending out of an outer periphery of the top portion and multiple indentations defined between two adjacent flanges. The middle portion is provided with multiple intermittently formed threads so that at least one flat area is formed in each thread and a gap is defined between two adjacent threads. The bottom portion has multiple slip-proof bars securely attached onto an outer periphery of the bottom portion.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the lamp fixture of the present invention;

FIG. 2 is an exploded perspective view of the lamp fixture in FIG. 1;

FIG. 3 is a schematic cross sectional view showing that the lamp fixture is inserted into a hole;

FIG. 4 is a perspective view of the lamp fixture with the enclosure removed;

FIG. 5 is a side plan view of the lamp fixture of the present invention with the enclosure removed; and

FIG. 6 is a schematic cross sectional view showing that the lamp fixture in FIGS. 4 and 5 is inserted into a hole having a dimension different from that of the hole shown in FIG. 3.

### DETAILED DESCRIPTION OF THE PREFERRED EMBODIMENT

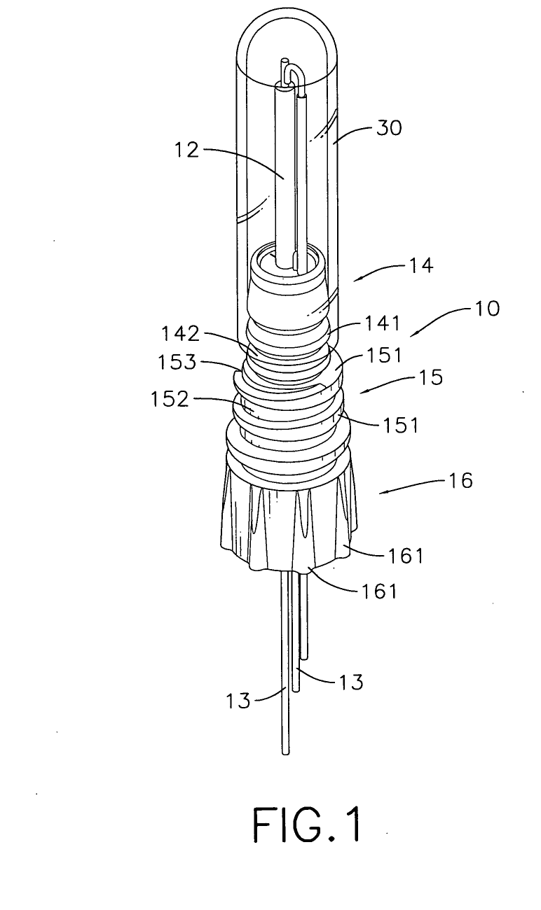

With reference to FIG. 1, the lamp fixture in accordance with the present invention includes a hollow conical body (10) and an enclosure (30) detachably mounted on top of the conical body (10).

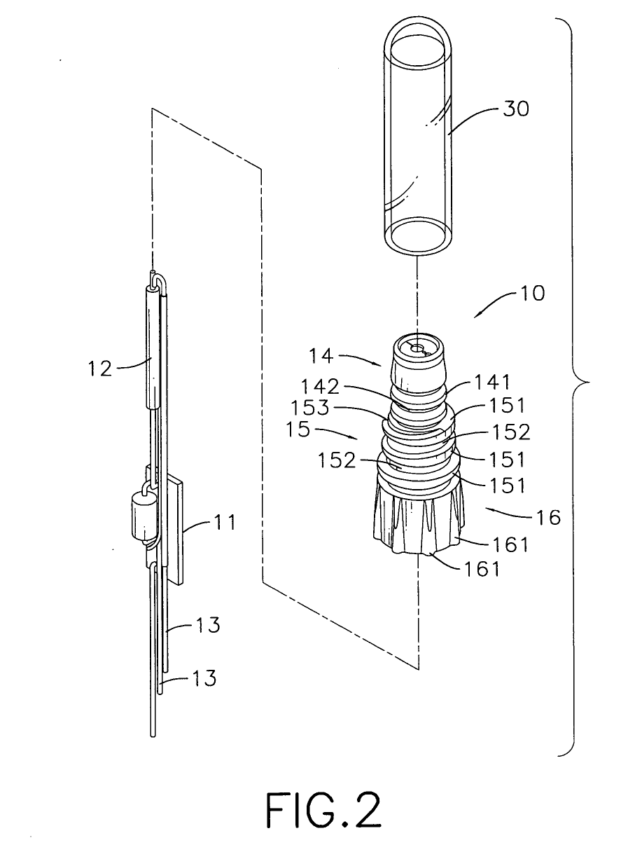

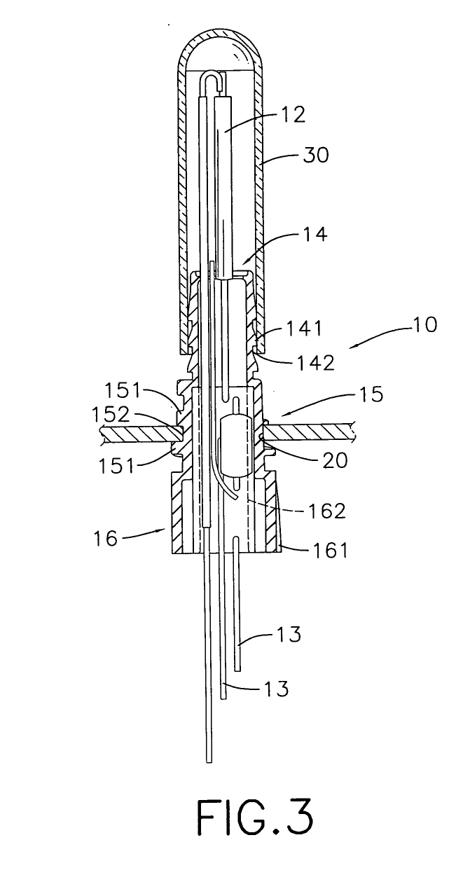

With reference to FIGS. 2 and 3, it is noted that the conical body (10) is divided into three portions, namely the top portion (14), the middle portion (15) and the bottom portion (16). The top portion (14) has multiple flanges (141) and multiple indentations (142) each being defined between two adjacent flanges (141). The middle portion (15) is provided with multiple intermittently formed threads (151). Due to the intermittent feature of the threads (151), a flat portion (153) is defined in each of the threads (151). An annular gap (152) is defined between two adjacent threads (151). The bottom portion (16) has multiple slip-proof bars (161) securely attached to an outer periphery of the bottom portion (16). The bottom portion (16) further has a positioning recess (162) defined in an inner periphery of the bottom portion (16).

In order to facilitate understanding of the application of the lamp fixture of the present invention, a lamp (12) electrically attached to a circuit board (11) which has two wires (13) extending out from the circuit board (11) is presented in the accompanying drawings.

When the lamp fixture of the present invention is assembled, it is noted that the lamp (12) together with the circuit board (11) as well as the two wires (13) is inserted into the conical body (10) from the bottom opening of the conical body (10) and the circuit board (11) is received in the positioning recess (162) in the bottom portion (16). After the lamp (12), the top portion (14) and the middle portion (15) are extended through a hole (20) defined in a car panel (not shown) by the user's holding the slip-proof bars (161) of the bottom portion (16), the enclosure (30) is mounted and securely engaged with the top portion (14). It is noted that because the conical body (10) has a tapered diameter the conical body (10) is able to extend through the through hole (20) in the car panel. Furthermore, due to the annular gap (152) between two adjacent threads (151), a periphery forming the through hole (20) is able to engage with a bottom face forming the annular gap (152) to secure the lamp fixture. The function of the flat area (153) is to allow an easy access of the lamp fixture into the hole (20). That is, the periphery forming the through hole (20) is able to pass through the flat area (153) easily and then the periphery of the through hole (20) is able to be clamped by the bottom face defining a certain annular gap (152).

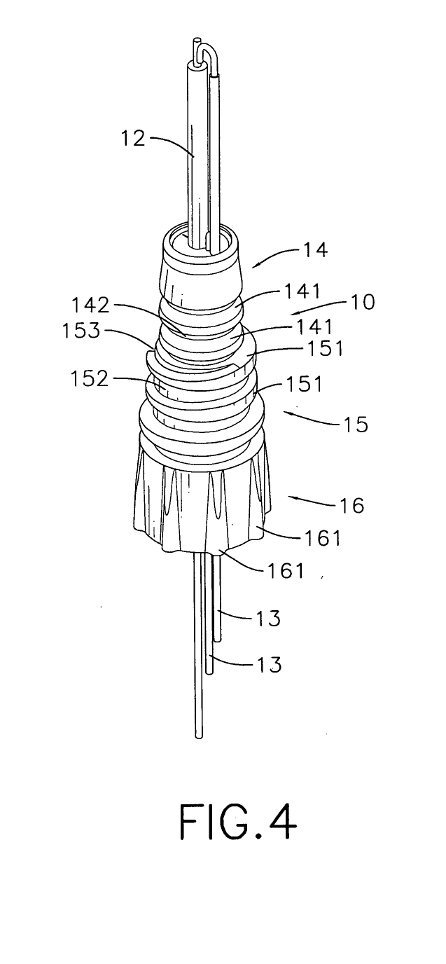

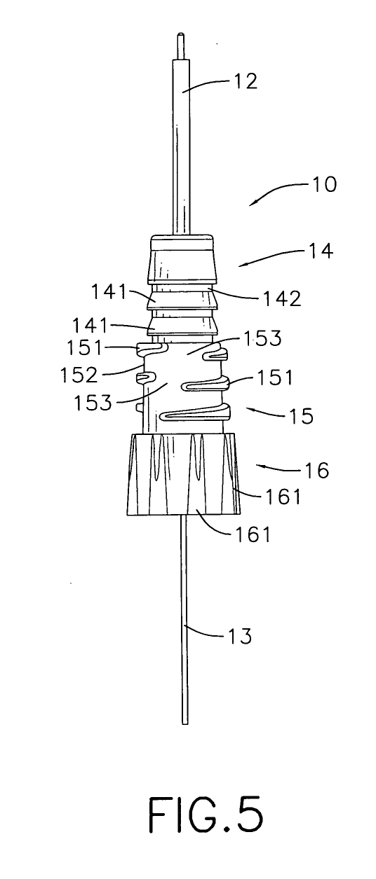

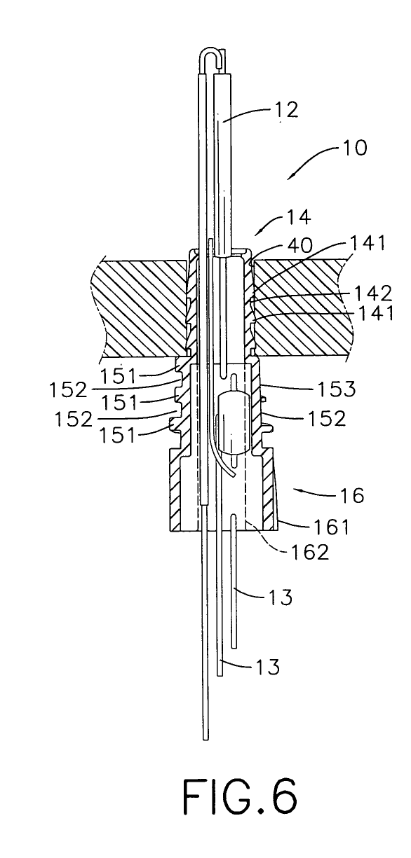

With reference to FIGS. 4, 5 and 6, it is noted that the lamp fixture of the present invention can still be applied without the enclosure (30) as applied in FIGS. 1, 2 and 3. When the lamp fixture of the present invention is applied to a secondary hole (40) having a diameter much smaller than that of the through hole (20) in FIG. 3, the multiple flanges (141) will engage with an inner periphery defining the secondary hole (40) and the bottom face defining the annular gap (152) is able to engage with a periphery defining the secondary hole (40) so as to position the lamp fixture on a surface having the secondary hole (40).

From the aforementioned discussion, it is noted that the lamp fixture of the present invention has the following advantages:

1. One lamp fixture can fit several sizes of holes, which is a great saving in cost.

2. Different colors can be applied to the enclosure to present colorful attractions.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An onboard lamp fixture comprising a hollow conical body adapted to receive therein a lamp, a circuit board electrically connected to the lamp and two wires extending out from the conical body, the conical body having a bottom opening for an extension of the lamp, the circuit board and the wires and a top opening for the lamp to extend out of the conical body, the conical body being divided into a top portion having multiple flanges formed on an outer periphery of the top portion and multiple indentations each defined between two adjacent flanges, a middle portion having multiple intermittently formed threads on an outer periphery of the middle portion and annular gaps each defined between two adjacent threads and a bottom portion,
whereby after the conical body is extended through a through hole, a bottom face defining the annular gap of each thread is able to engage with an outer periphery defining the through hole and the flanges are able to securely engage with an inner periphery defining the through hole to secure the conical body.

2. The lamp fixture as claimed in claim 1, wherein the bottom portion has multiple slip-proof bars securely attached to an outer periphery of the bottom portion.

3. The lamp fixture as claimed in claim 2, wherein the bottom portion has a positioning recess defined in an inner periphery of the bottom portion for accommodation of the circuit board.

4. The lamp fixture as claimed in claim 1, wherein a flat portion is defined in each of the threads of the middle portion for easy access to the through hole.

5. The lamp fixture as claimed in claim 2, wherein a flat portion is defined in each of the threads of the middle portion for easy access to the through hole.

6. The lamp fixture as claimed in claim 3, wherein a flat portion is defined in each of the threads of the middle portion for easy access to the through hole.

7. The lamp fixture as claimed in claim 6 further comprising an enclosure detachably connected to the top portion of the conical body for enclosing the lamp which is extended out of the conical body.
